(19) United States
(12) Patent Application Publication
(10) Pub. No.: US 2017/0255869 A1
(43) Pub. Date: Sep. 7, 2017

(54) Method and System of Switching Output Interfaces for a Computer System

(71) Applicant: ACER INCORPORATED, New Taipei City (TW)

(72) Inventors: Shu-Cheng Liu, New Taipei City (TW); Yin-Hsong Hsu, New Taipei City (TW); Ling-Fan Tsao, New Taipei City (TW); Shu-Chun Liao, New Taipei City (TW)

(21) Appl. No.: 15/378,064

(22) Filed: Dec. 14, 2016

(30) Foreign Application Priority Data
Mar. 2, 2016 (TW) 105106240

(51) Int. Cl. G06N 7/00; G06N 99/00

(52) U.S. Cl. CPC G06N 7/005; G06N 99/005

(57) ABSTRACT

A method of switching output interfaces for a computer system includes recording a plurality of system operation statuses of a multimedia signal corresponding to the computer system to switch from a first output interface to a second output interface and generating at least a switching condition; and switching the multimedia signal of the computer system from the first output interface to the second output interface when an operating status of the computer system matches the at least a switching condition.

### BACKGROUND OF THE INVENTION

1. Field of the Invention

The present invention relates to a method and system of switching output interfaces for a computer system, and more particularly, to a method and system of switching output interfaces for a computer system capable of switching output interfaces by a learning manner.

2. Description of the Prior Art

With the development of multimedia technology, the need of audio & video (AV) products in daily life of users has been increasing. In general, the users adopt different multimedia output devices according to personal habits, such as, playing sound via speakers when watching movie on personal computers, listening to music by headset or using built-in speakers of HDMI (High Definition Multimedia Interface) device when connected to the HDMI device. Although by default settings of a sound driver program or operation of operating system, i.e. Windows, the users may switch to output AV signal to a specific playing device, however, when the users want to play sound via speakers with the HDMI device connected to the computer system, the users need to remove the unused HDMI device or change the playing device settings in the computer system. Therefore, it not only results in inconveniences to the users, but also consumes a connecter of the playing devices when switching the output interfaces by connecting or removing the connecter again and again.

### SUMMARY OF THE INVENTION

To solve the above mentioned problems, the present invention provides a method and system of switching output interfaces for a computer system to enhance the conveniences.

An embodiment of the present invention discloses a method of switching output interfaces for a computer system comprising recording a plurality of system operation statuses of a multimedia signal corresponding to the computer system to switch from a first output interface to a second output interface and generating at least a switching condition; and switching the multimedia signal of the computer system from the first output interface to the second output interface when an operating status of the computer system matches the at least a switching condition.

An embodiment of the present invention further discloses a computer system comprising a plurality of output interfaces; a processor; a storage apparatus for storing a program code, wherein the program code causes the processor to perform a method of switching output interface, and the method of switching output interface comprises recording a plurality of system operation statuses of a multimedia signal corresponding to the computer system to switch from a first output interface to a second output interface and generating at least a switching condition; and switching the multimedia signal of the computer system from the first output interface to the second output interface when an operating status of the computer system matches the at least a switching condition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to an embodiment of the present invention.

FIG. 2 is a schematic diagram of an output interface switching flowchart according to an embodiment of the present invention.

FIG. 3 is a schematic diagram of a switching condition generation flowchart according to an embodiment of the present invention.

FIGS. 4A and 4B are the schematic diagrams of a switching condition generation according to an embodiment of the present invention.

FIG. 5 is a schematic diagram of an operation flowchart of the output interfaces switching flowchart applied to the computer system.

### DETAILED DESCRIPTION

A computer system may record system events and system operation statuses. Therefore, the present invention utilizes a computer system to learn timing when user switches output interfaces, and to user-friendly and automatically switch output interface and thereby simplify complicated steps of switching output interfaces.

Please refer to FIG. 1. FIG. 1 is a schematic diagram of a computer system 10 according to an embodiment of the present invention. The computer system 10 includes a processor 110, a storage device 120 and a plurality of output interfaces 130. The storage device 120 stores program codes to instruct the processor 110 to execute relative operations. The plurality of output interfaces 130 are different multimedia output ports, e.g., audio output ports of headsets and speakers, HDMI interface, optical fiber output etc., and not limited thereto. Since the computer system 10 has the plurality of output interfaces 130, when a user uses the computer system 10 to play audio, the computer system 10 follows default system settings to play the audio. Meanwhile, if the user wants to use a play device which is different from the original default play device, the user needs to reset system settings or switch devices manually and results in inconveniences. To improve convenience, an embodiment of the present invention provides a mechanism of switching output interfaces by learning timing when the user switches the output interface, automatically and user-friendly switches the output interface, and thereby simplifies complicated steps of switching the output interfaces.

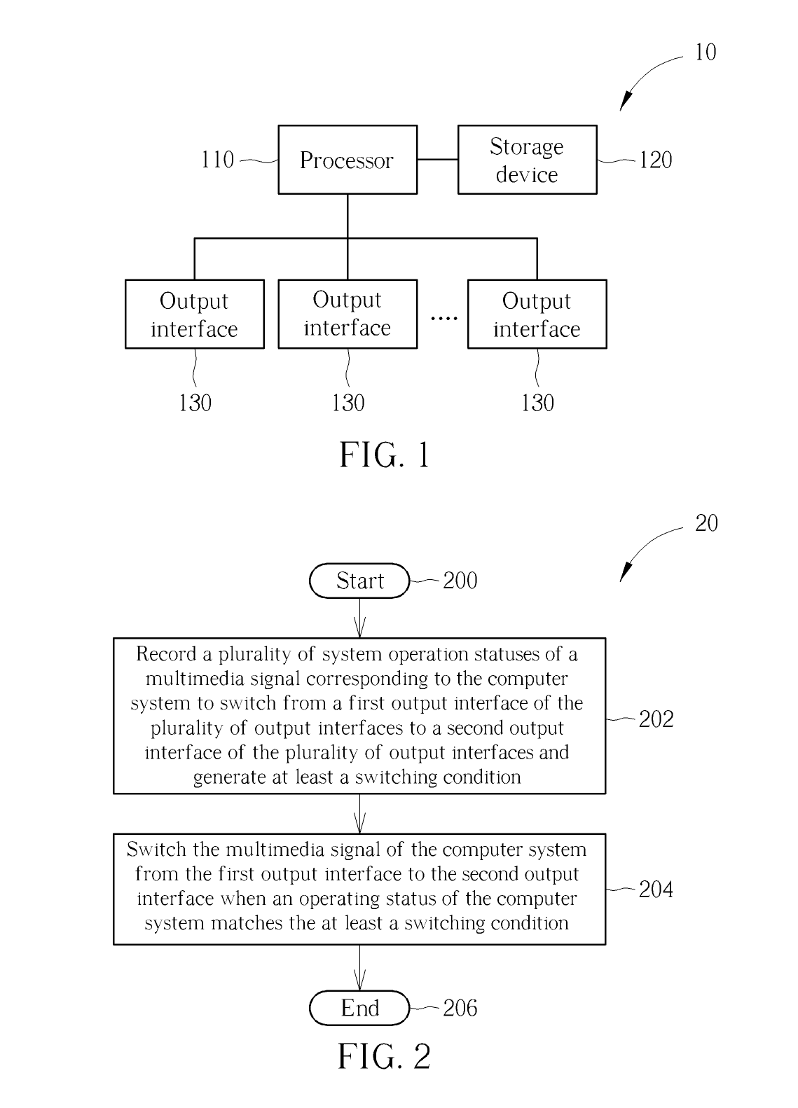

Please refer to FIG. 2. FIG. 2 is a schematic diagram of an output interface switching flowchart 20 according to an embodiment of the present invention. The output interfaces switching flowchart 20 can be compiled as program code and stored in the storage device 120 to instruct the processor 110 to execute corresponding operations. The output interfaces switching flowchart 20 includes following steps:

Step 200: Start.

Step 202: Record a plurality of system operation statuses of a multimedia signal corresponding to the computer system 10 to switch from a first output interface of the plurality of output interfaces 130 to a second output interface of the plurality of output interfaces 130 and generate at least a switching condition.

Step 204: Switch the multimedia signal of the computer system 10 from the first output interface to the second output interface when an operating status of the computer system matches the at least a switching condition.

Step 206: End.

According to the output interfaces switching flowchart 20, the computer system 10 records the plurality of system operation statuses of a multimedia signal corresponding to the computer system 10 to switch from a first output interface to a second output interface and generates at least a switching condition. After the generation of the switching condition, when the operating status of the computer system 10 matches the switching condition, the computer system 10 automatically switches the multimedia signal of the computer system 10 from the first output interface to the second output interface. In other words, according to the output interfaces switching flowchart 20, the computer system 10 records and learns habits of the user, which are utilized as a reference to automatically switch the output interface. For example, when the user switches the output interface from the output interface of headset to the output interface of home theater right after executing a program every time, the computer system 10 judges the user has a demand of switching the output interfaces right after executing the program, and generates a corresponding switching condition to automatically (or asks the user if needed or not) switch the output interface when the user executes the program again. For another example, when the user switches the output interface from the output interface of speakers to the output interface of a headset right after turning down the volume of the computer system under 50 (assume that default range of volume is 0-100), the computer system 10 judges the user has a demand of switching the output interfaces right after turning down the volume of the computer system under 50 every time. Therefore, when the user turns down the volume of the computer system under 50 again, the computer system 10 automatically switches the output interface. As a result, the computer system 10 simplifies complicated steps of switching output interfaces and improves conveniences.

The examples mentioned above briefly explain that by learning habits of the user, the present invention automatically switches the output interface. Notably, those skilled in the art may appropriately design information needed to be recorded, learning methods or generation flowchart of switching condition of the computer system 10 according to demands of different systems. For example, according to different demands, when (or before) the output interface changes, the computer system 10 may record system operation statuses (e.g., S1-S5), execution or shut down of specific programs, system volume adjustment, status of internet connection, location information, calendar information and etc. In addition, recorded content may include corresponding details according to system demands, e.g., program name when the computer system executes or shuts down the program, system volume after changes, name of internet connection, priority of calendar information and so on, but not limited thereto. For example, the user switches the output interface when the user changes from browsing an educational website to an entertainment website (e.g., YouTube) via the computer system 10, and the computer system 10 records above mentioned system operation statuses, which includes website name, website address, browsing time, the output interface change status and so on. For another example, the user switches the output interface when an important meeting shows on the calendar of computer system 10, and the computer system 10 records the above mentioned system operation statuses, which includes meeting time, meeting name, meeting place, founder, the output interface change status and so on.

In addition, the computer system 10 may adopt different recording methods according to computer system statuses or user's demands, for example, when free system memory is enough, sets recording time T as 1 minute to adequately record the system operation statuses. On the contrary, the recording time T (e.g., 5 seconds) may be shortened to satisfy demands of the computer system or the user. Therefore, the computer system 10 of the present invention records and learns habits of the user by different manners to generate different switching conditions according to the recorded system operation statuses of the computer system, and predicts whether to switch the output interface or not.

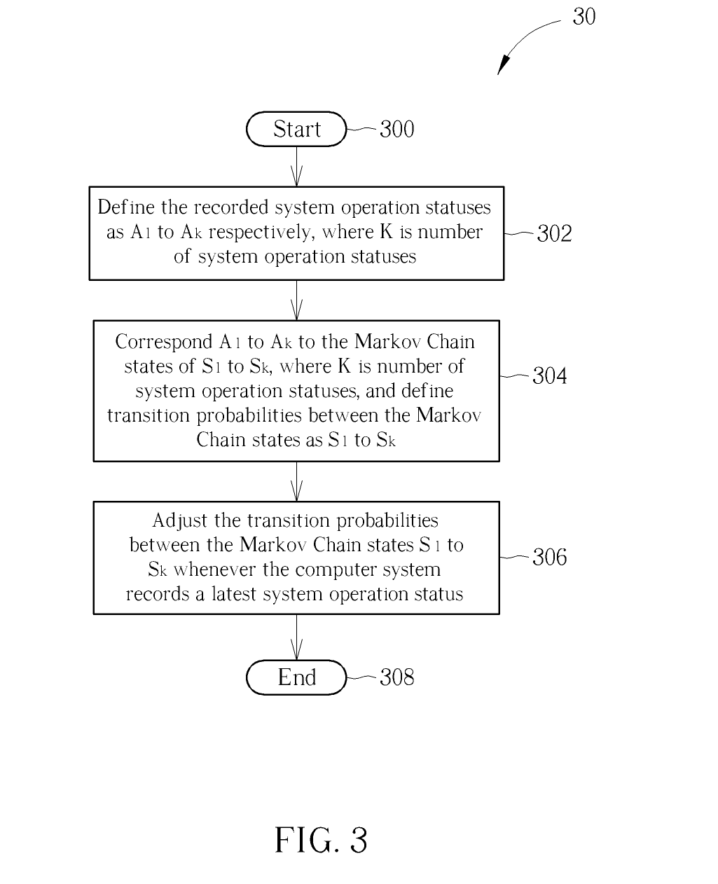

By recording the system operation statuses, the computer system 10 may analyze the system operation statues when the user switches the output interface, and thereby generates different switching conditions. For example, mathematical models can be applied to generate probabilities or weighting of the switching condition. In an embodiment, the computer system 10 adopts the Markov Chain to generate the switching condition. Please refer to FIG. 3. FIG. 3 is a schematic diagram of a switching condition generation flowchart 30 according to an embodiment of the present invention. The switching condition generation flowchart 30 may be applied to the Step 202 of the output interfaces switching flowchart 20 to generate switching conditions according to the system operation statuses. The switching condition generation flowchart 30 can be compiled as program code and stored in the storage device 120 of the computer system 10. The switching condition generation flowchart 30 includes the following steps:

Step 300: Start.

Step 302: Define the recorded system operation statuses as A₁ to Aₖ respectively, where K is number of system operation statuses.

Step 304: Correspond A₁ to Aₖ to the Markov Chain states of S₁ to Sₖ, where K is number of system operation statuses, and define transition probabilities between the Markov Chain states as S₁ to Sₖ .

Step 306: Adjust the transition probabilities between the Markov Chain states S₁ to Sₖ whenever the computer system 10 records a latest system operation status.

Step 308: End.

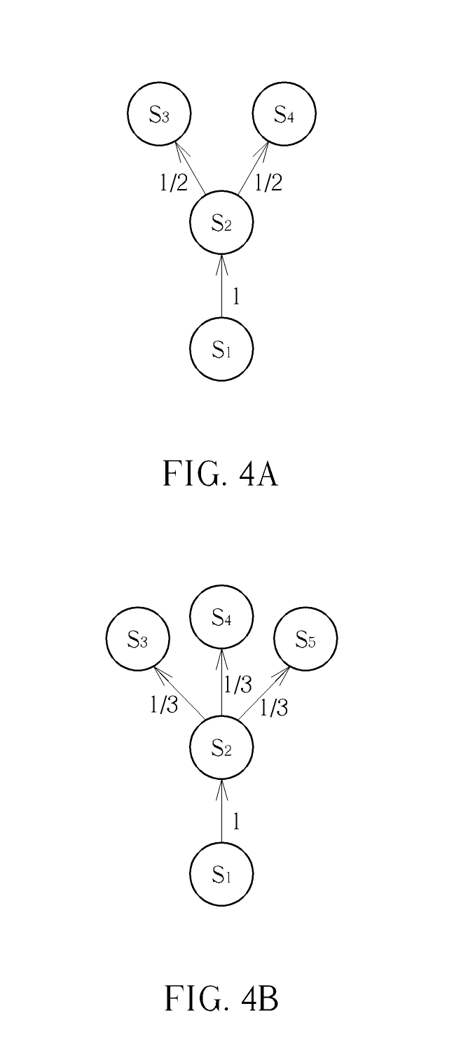

According to the switching condition generation flowchart 30, the computer system 10 learns behavior of the user by recording and making statistics of the system operation statuses, and generates switching condition according to the Markov Chain model. The applications of Markov Chain model is well known in the art, to explain clearly, the following embodiments are operated to explain with FIGS. 4A and 4B. When the computer system 10 records two types of three-stage system operation statuses before the user switches the output interface to headset, which is A₁→A₂→A₃ and A₁→A₂→A₄. At the same time, the computer system 10 corresponds the system operation statuses from A₁ to A₄ to the Markov Chain states of S₁ to S₄ . Then the computer system 10 defines the transition probability between S₁ and S₂ as 1, and the transition probabilities between S₂ and S₃, S₂ and S₄ as ½, which is shown in FIG. 4A. Then, when the computer system 10 records a latest system operation status A₁→A₂→A₅, as shown in FIG. 4B, the transition probability between S₁ and S₂ is 1, and the transition probabilities between S₂ and S₃, S₂ and S₄, S₂ and S₅ are ⅓. Then, when the user executes the system operation status A₁ and A₂ again, according to the transition probabilities between the states of the Markov Chain model, the computer system 10 generates value of switching conditions as follows: S₁→S₂→S₃: 1*⅓=⅓, S₁→S₂→S₄: 1*⅓=⅓ and S₁→S₂→S₅: 1*⅓=⅓. In this embodiment, a pre-determined threshold may be defined by the user or the computer system 10. When the value of switching condition is higher than the threshold, the computer system 10 predicts that the user is going to switch the output interface to a headset. In contrast, when the value of switching condition is lower than the threshold, the computer system 10 predicts that the user is not going to switch the output interface. Therefore, the user will not need to switch the output interface himself, but merely by prediction result of the computer system to switch the output interface or not, which simplifies the complicated steps of switching the output interfaces, and improves convenience.

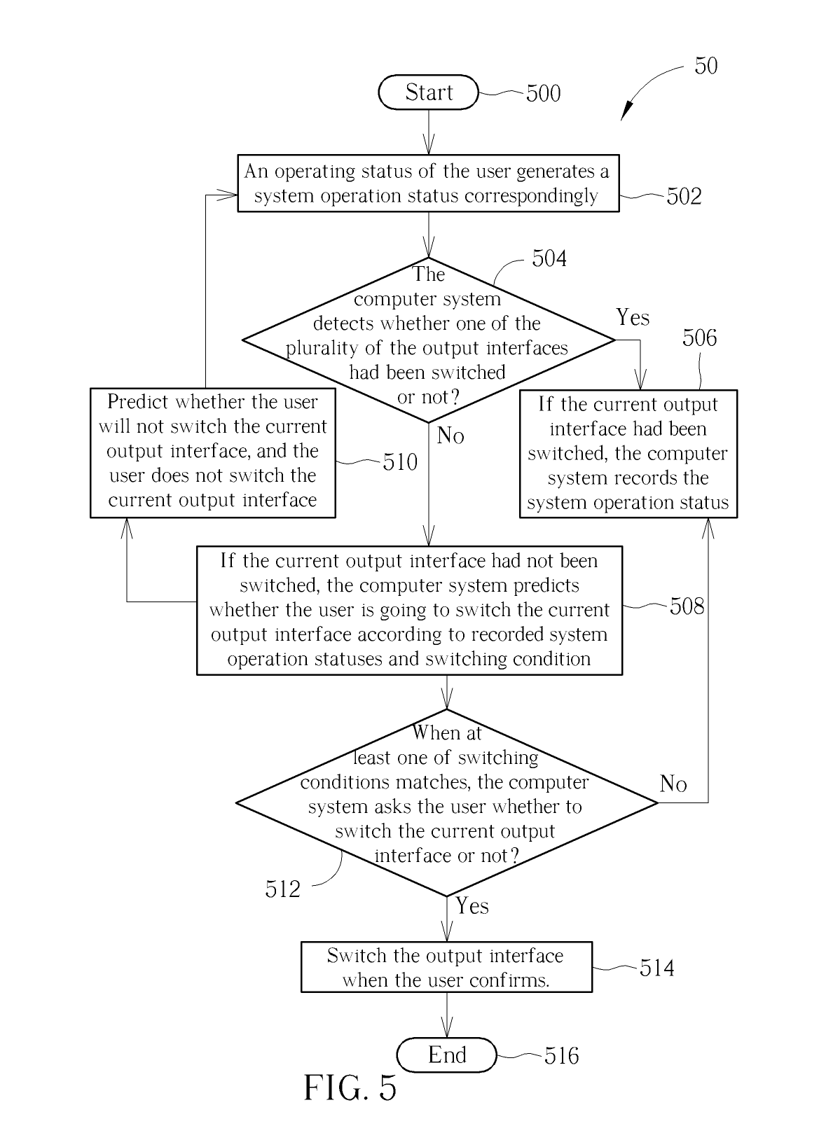

As a result, by the output interfaces switching flowchart 20, the computer system 10 can show prediction result of whether the user is going to switch the output interface or not on the monitor, and ask whether the user would like to switch the output interface or not. For example, the Toast Notification of Microsoft operating system may be utilized to ask whether the user is going to switch the output interface or not. Therefore, the user only needs to check the Toast Notification of the operating system to automatically switch the output interface. Furthermore, please refer to FIG. 5. FIG. 5 is a schematic diagram of an operation flowchart 50 of the output interfaces switching flowchart 20 applied to the computer system 10. The operation flowchart 50 includes following steps:

Step 500: Start.

Step 502: An operating status of the user generates a system operation status correspondingly.

Step 504: The computer system 10 detects whether one of the plurality of the output interfaces 130 had been switched or not.

Step 506: If the current output interface had been switched, the computer system 10 records the system operation status.

Step 508: If the current output interface had not been switched, the computer system 10 predicts whether the user is going to switch the current output interface according to recorded system operation statuses and the generated at least a switching condition.

Step 510: Predict whether the user will not switch the current output interface, and the user does not switch the current output interface.

Step 512: When at least one of switching conditions matches, the computer system 10 asks the user whether to switch the current output interface to another output interface of the plurality of the output interfaces 130 or not.

Step 514: Switch the output interface when the user confirms.

Step 516: End.

According to the operation flowchart 50, when the user operates on the computer system 10, the operating status generates a corresponding system operating status. For example, when the user first executes a music player program and then switches to the output interface of a headset. Meanwhile, the computer system 10 detects the current output interface had been switched, which means the user switches the output interface when executing the above mentioned operating status. Therefore, the computer system 10 records the system operating status corresponding to the output interface to learn the habits of the user. On the contrary, when the user operates on the computer system 10 without switching the output interface, the computer system 10 predicts whether the user will switch the output interface according to the current system operation status and the generated switching conditions from the switching condition generation flowchart 30. When the value of the switching conditions generated from the switching condition generation flowchart 30 is lower than the threshold, the computer system 10 will not ask the user to switch the output interface. On the other hand, when the value of the switching conditions generated from the switching condition generation flowchart 30 is higher than the threshold, the computer system 10 utilizes the Toast Notification of the Microsoft operating system to ask the user whether to switch the current output interface to a predicted output interface or not. Notably, when the computer system 10 predicts that the user will not switch the output interface, but the user switches the output interface, or the computer system 10 predicts that the user will switch the output interface, but the user does not switch the output interface, the computer system 10 may increase or decrease the transition probability or the weighting of the Markov Chain model corresponding to the system operation statuses. Therefore, the computer system 10 may adjust appropriately according to habits and preferences of the user so as to improve accuracy of switching the output interface and simplify complicated steps of switching the output interfaces for the user.

Notably, the above mentioned embodiments are used to explain the spirit of the present invention, proper modifications and alterations may be made by those skilled in the art, but not limited thereto. For example, in addition to utilize the Markov Chain model to generate the switching condition, the present invention may adopt weightings to generate the switching condition, e.g., the computer system 10 or the user may define different weightings to different system operation statuses, and generate the switching condition according to the weightings of the system operation statuses. In addition, the present invention is not only applied to the output switching of the computer system, but also those interfaces or devices which can be detected by the computer system, e.g., the application of switching multiple monitors. When the user is using the multi-monitors computer system, the computer system predicts which monitor the user is going to use according to the learned habits from the user. For another example, the application of adjusting peripheral or output devices, e.g., monitor contrast, monitor brightness, monitor color cast, brightness of keyboard backlight or glittering of keyboard backlight and so on. According to the environment the user is used to, the computer system appropriately adjusts the peripheral or output devices so as to be friendlier and more convenient for the user to utilize the computer system. Therefore, the present invention provides a switching method which not only learns habits of the user, predicts behaviors of the user, but also automatically switches or adjusts the corresponding interface or device to improve convenience.

In summary, the present invention provides a method of switching output interfaces for a computer system to simplify complicated steps when a user uses multiple output interfaces, and provides a method of switching output interfaces by learning habits of the user to improve practicability and convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of switching output interfaces for a computer system comprising:
recording a plurality of system operation statuses of a multimedia signal corresponding to the computer system to switch from a first output interface to a second output interface and generating at least a switching condition; and
switching the multimedia signal of the computer system from the first output interface to the second output interface when an operating status of the computer system matches the at least a switching condition.

2. The method of claim 1, wherein the plurality of system operation statuses of the multimedia signal corresponding to the computer system to switch from the first output interface to the second output interface is performed in a predetermined time period.

3. The method of claim 1, wherein the at least a switching condition is generated by a weighting design or a mathematical model.

4. The method of claim 3, wherein the mathematical model is a Markov Chain model.

5. The method of claim 1, wherein the system operation statuses include at least one of an operating status of the computer system, executing or shutting down at least a program, system volume adjustment, status of internet connection, location information or calendar information.

6. A computer system, comprising:
a plurality of output interfaces;
a processor; and
a storage device, for storing program code, wherein the program code instructs the processor to execute the following steps:
recording a plurality of system operation statuses of a multimedia signal corresponding to the computer system to switch from a first output interface to a second output interface and generating at least a switching condition; and
switching the multimedia signal of the computer system from the first output interface to the second output interface when an operating status of the computer system matches the at least a switching condition.

7. The computer system of claim 6, wherein the plurality of system operation statuses of the multimedia signal corresponding to the computer system to switch from the first output interface to the second output interface is performed in a predetermined time period.

8. The computer system of claim 6, wherein the at least a switching condition is generated by a weighting design or a mathematical model.

9. The computer system of claim 8, wherein the mathematical model is a Markov Chain model.

10. The computer system of claim 6, wherein the system operation statuses include at least one of an operating status of the computer system, executing or shutting down at least a program, system volume adjustment, status of internet connection, location information or calendar information.
